(19) United States
(12) Patent Application Publication
(10) Pub. No.: US 2025/0026397 A1
(43) Pub. Date: Jan. 23, 2025

(54) RACK SHAFT, METHOD FOR MANUFACTURING SAME, AND RACK-AND-PINION STEERING GEAR UNIT

(71) Applicant: NSK STEERING & CONTROL, INC., Tokyo (JP)

(72) Inventors: Kittipon ROONGVASHIRA, Gunma (JP); Yoshifumi KUROKAWA, Gunma (JP)

(73) Assignee: NSK STEERING & CONTROL, INC., Tokyo (JP)

(21) Appl. No.: 18/685,812

(22) PCT Filed: Aug. 16, 2022
(86) PCT No.: PCT/JP2022/030994

§ 371 Date: Sep. 10, 2024

(30) Foreign Application Priority Data
Aug. 23, 2021 (JP) 2021-135439

(51) Int. Cl. B62D 3/12

(52) U.S. Cl. CPC B62D 3/126

(57) ABSTRACT

A rack portion (21) includes a hardened layer (26) over an entire circumference on a radially outer portion including the rack teeth (20). A depth (tb) of a portion of the hardened layer (26) on an opposite side to the rack teeth (20) in a radial direction is shallower than a depth (ts) of portions of the hardened layer (26) on both sides of the rack teeth (20) in a tooth width direction.

### TECHNICAL FIELD

The present disclosure relates to a rack shaft that forms a rack and pinion type steering gear unit.

### BACKGROUND ART

In a steering device for use in automobiles, when a driver operates (rotates) a handlebar, the rotation of the handlebar is transmitted to a pinion shaft of a steering gear unit through a steering shaft or an intermediate shaft. When a rack shaft of the steering gear unit is displaced in a width direction of the vehicle by the rotation of the pinion shaft, a pair of tie rods are pushed and pulled, imparting a steering angle on steering wheels.

The steering gear unit is configured by combining a pinion shaft including pinion teeth on an outer circumferential surface and a rack shaft including rack teeth engaged with the pinion teeth on a portion of the outer circumferential surface.

In recent years, a rack and pinion type steering gear unit is required to respond to a need for lighter weight and higher output. JP2020-169676A (Patent Literature 1) describes a rack shaft in which a hardened layer is formed over the entire circumference by applying induction hardening treatment on a portion where the rack teeth are provided. According to the rack shaft described in JP2020-169676A, bending strength and strength (axial strength) of the rack teeth can be improved and embrittlement can be reduced. Therefore, for the rack shaft, lighter weight and/or higher output can be implemented.

### CITATION LIST

### Patent Literature

Patent Literature 1: JP2020-169676A

### SUMMARY OF INVENTION

### Technical Problem

For the rack shaft described in JP2020-169676A, manufacturing cost may increase.

For the rack shaft described in JP2020-169676A, a depth (thickness) of the hardened layer becomes deeper (greater) in order from a portion on a radially inner side of a tooth bottom, portions on both sides of the tooth in a width direction, and a portion on an opposite side to the rack teeth in the radial direction. Here, the portion on the opposite side to the rack teeth in the radial direction is hardly cooled down, because a surface area thereof is smaller than that of the portion on the radially inner side of the tooth bottom. Therefore, efficiency of forming the hardened layer with the induction hardening treatment is low, and there is possibility that manufacturing cost of the rack shaft may increase.

An object of the disclosure is to provide a rack shaft that can reduce manufacturing cost while ensuring bending strength, and a method for manufacturing the rack shaft.

### Solution to Problem

As a result of close study on means for solving the problems mentioned above, the inventors of the disclosure could confirm that, in use state (while the vehicle is driving), a tensile load is applied from the tie rods to the rack tooth side portion of the rack shaft, and in a relatively severe load condition where stress tends to be concentrated on the rack teeth, the load applied from the tie rods to the portion on the opposite side of the rack teeth in the radial direction of the rack shaft was a compressive load. The inventors could confirm that, to ensure strength of the rack teeth against the tensile load applied from the tie rods in the use state, it is important to ensure hardening of the portion on the radially inner side of the end of both sides in a tooth width direction of the tooth bottom of the rack shaft. It is known that, for a metal material, the Young's modulus becomes low when the hardness is high, and the Young's modulus becomes high when the hardness is low. Therefore, the inventors could confirm that, when the depth of the hardened layer on the opposite side (back surface side) to the rack teeth in a radial direction is deeper than other portions, the rigidity of the back surface side portion in the rack shaft decreased, leading to increased deformation when a bending load was applied to the rack shaft. and as a result, the stress generated on the tooth surface of the rack teeth increased. The disclosure was completed based on the above findings.

The rack shaft according to an aspect of the disclosure includes,
a rack portion including rack teeth on an outer circumferential surface, in which
the rack portion has a hardened layer over an entire circumference on a radially outer portion (surface layer portion) including the rack teeth, and
a depth (thickness) of a portion on an opposite side to the rack teeth in a radial direction of the hardened layer is equal to or shallower (smaller) than depths of portions of the hardened layer on both sides of the rack teeth in a tooth width direction.

In the rack shaft according to an aspect of the disclosure, a depth of a portion of the hardened layer on a radially inner side of an end of a tooth bottom in the tooth width direction between adjacent rack teeth in the axial direction is deeper (bigger) than the depths of the portions of the hardened layer on both sides of the rack teeth in the tooth width direction.

In the rack shaft according to an aspect of the disclosure, the depth of the hardened layer becomes gradually shallower in a circumferential direction, from the portion on the radially inner side of the end of the tooth bottom in the tooth width direction, toward the portion on the opposite side to the rack teeth in the radial direction.

In the rack shaft according to an aspect of the disclosure, a depth of a portion of the hardened layer on a radially inner side of an intermediate portion of the tooth bottom in the tooth width direction is shallower than the depth of the portion on the opposite side to the rack teeth in the radial direction.

A method for manufacturing a rack shaft according to an embodiment of the disclosure is a method for manufacturing the rack shaft according to one aspect of the disclosure, the method including,
performing heat treatment such as hardening or tempering on the rack portion by energizing a high-frequency induction coil disposed around the rack portion, in which
while performing the heat treatment on the rack portion, a center axis of the high-frequency induction coil is disposed to be offset from a center axis of the rack portion to the opposite side to the rack teeth in the radial direction. In other words, in the heat treatment, the size of a gap between the high-frequency induction coil and the rack portion becomes bigger on the back surface side compared to the rack tooth side.

Here, for the high-frequency induction coil, a unit having a shape similar to the contour shape of the rack portion can be used.

A rack and pinion type steering gear unit according to an aspect of the disclosure includes,
a pinion shaft including pinion teeth on an outer circumferential surface, and
a rack shaft including a rack portion including rack teeth engaged with the pinion teeth on a portion in a circumferential direction of an outer circumferential surface, in which
the rack shaft is configured with the rack shaft according to the aspect of the disclosure.

### Advantageous Effects of Invention

According to the rack shaft of an aspect of the disclosure, it is possible to reduce the manufacturing costs while ensuring bending strength.

### BRIEF DESCRIPTION OF DRAWINGS

FIG. 1 is a perspective view illustrating a steering device including a rack and pinion type steering gear unit according to an embodiment of the disclosure.

FIG. 2 is a partial cross-sectional view illustrating the rack and pinion type steering gear unit according to the embodiment.

FIG. 3 is a cross-sectional view taken along the line X-X of FIG. 2.

FIG. 4 is a perspective view illustrating a rack shaft taken out.

FIG. 5 is a cross-sectional view taken along the line Y-Y of FIG. 4.

FIGS. 6A, 6B, and 6C are cross-sectional views illustrating processes of forming rack teeth in order.

FIG. 7 is a cross-sectional view illustrating how induction hardening treatment is performed on the rack shaft.

FIG. 8 is a schematic view provided to explain load applied on the rack shaft.

FIGS. 9A and 9B are views illustrating two other examples of a cross-sectional shape of the rack shaft.

### DESCRIPTION OF EMBODIMENTS

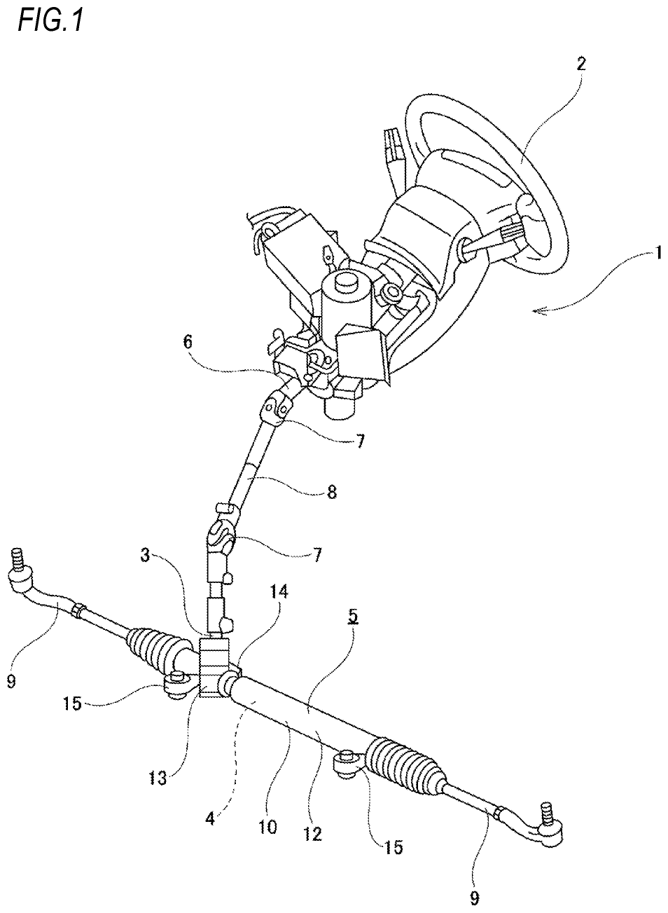

An embodiment of the disclosure will be described with reference to FIGS. 1 to 7. A rack shaft 4 of the present embodiment has a structure that can reduce manufacturing costs while ensuring bending strength by regulating a depth (thickness) of a hardened layer 26. Hereinbelow, an overall structure of a steering device 1 and a structure of a steering gear unit 5 are first explained, and then a depth of the hardened layer 26 of the rack shaft 4 is explained, and further, a method of manufacturing the rack shaft 4 is explained. In the following description, a front and rear direction indicates a front and rear direction of the vehicle, an up and down direction indicates an up and down direction of the vehicle, and a left and right direction indicates a width direction of the vehicle.

As illustrated in FIG. 1, the steering device 1 imparts a desired steering angle to left and right steering wheels (not illustrated) by converting a rotational movement of a handlebar 2 operated by a driver into a reciprocating linear movement by a rack and pinion type steering gear unit 5 including a pinion shaft 3 and the rack shaft 4. Therefore, the handlebar 2 is fixed to a rear end of a steering shaft 6. The front end of the steering shaft 6 is connected to a base end of the pinion shaft 3 through a pair of universal joints 7 and an intermediate shaft 8. Ends of both sides in an axial direction of the rack shaft 4 engaged with the pinion shaft 3 are connected to a pair of tie rods 9 connected to left and right steering wheels, respectively.

The steering gear unit 5 includes a housing 10, the pinion shaft 3, the rack shaft 4, and a pressing mechanism 11.

The housing 10 includes a rack accommodating portion 12 that accommodates an axially intermediate portion of the rack shaft 4, a pinion accommodating portion 13 that accommodates a front half of the pinion shaft 3, a cylinder portion 14 that accommodates the pressing mechanism 11, and a pair of mounting flange portions 15 for fixing to a body of the vehicle. An inner space of the rack accommodating portion 12, an inner space of the pinion accommodating portion 13, and an inner space of the cylinder portion 14 are communicated with each other.

The housing 10 is integrally manufactured by die-casting a light alloy such as aluminum alloy. Alternatively, the housing 10 can also be formed by joining a plurality of parts by bolting, welding, or the like.

The rack accommodating portion 12 has a cylindrical shape extending in the left and right direction, and has openings at the ends of both sides in the axial direction (both sides in the left and right direction). The rack accommodating portion 12 is disposed horizontally.

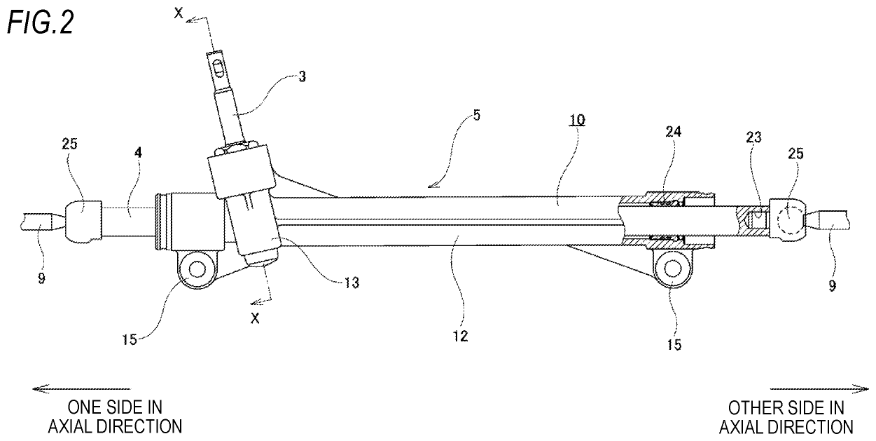

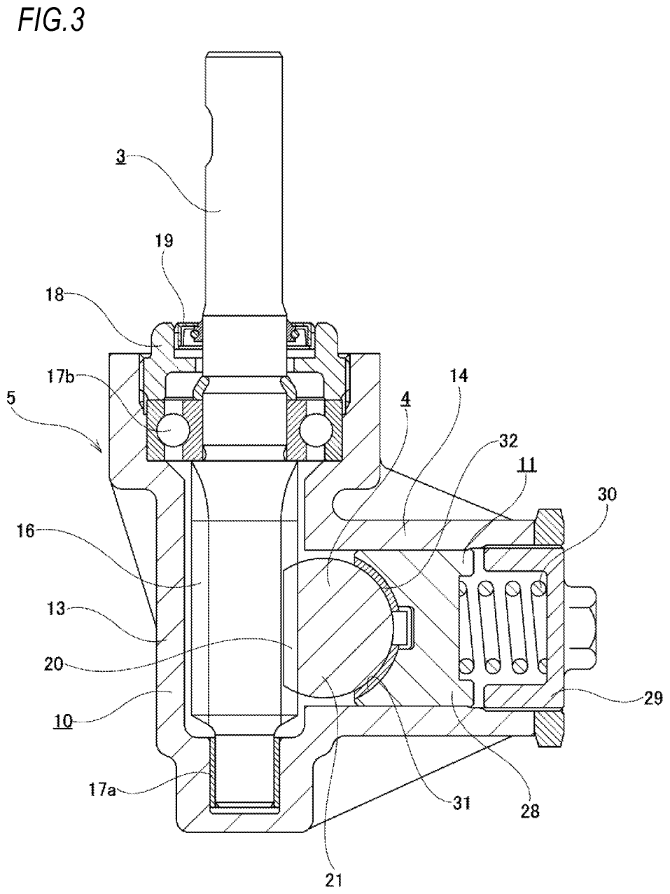

The pinion accommodating portion 13 has a bottomed cylindrical shape and an opening at an upper end. The pinion accommodating portion 13 is disposed on a front side of the rack accommodating portion 12 (on a left side in FIG. 3), on a position biased to one side in the axial direction of the rack accommodating portion 12 (on a left side in FIGS. 1 and 2), and with twisted positional relation with respect to the rack accommodating portion 12. In other words, the center axis of the pinion accommodating portion 13 and the center axis of the rack accommodating portion 12 have a twisted positional relation. When viewed from the front and rear direction, the center axis of the pinion accommodating portion 13 is not disposed in a direction orthogonal to the center axis of the rack accommodating portion 12, but is disposed to be tilted to the orthogonal direction.

The cylinder portion 14 has an approximately cylindrical shape. The cylinder portion 14 is disposed on a rear side of the rack accommodating portion 12 (on the right side in FIG. 3) and on a position biased to one side of the rack accommodating portion 12 in the axial direction. Specifically, the cylinder portion 14 is disposed on the same position as that of the pinion accommodating portion 13 in the axial direction of the rack accommodating portion 12. The cylinder portion 14 extends in the front and rear direction of the directions orthogonal to the rack accommodating portion 12. Therefore, the center axis of the cylinder portion 14 is disposed in the direction orthogonal to the center axis of the rack accommodating portion 12.

The pair of mounting flange portions 15 are disposed on the front side of the rack accommodating portion 12 to be spaced apart from each other in the axial direction of the rack accommodating portion 12. The housing 10 is fixed to the body of the vehicle using a fixing member such as a bolt or stud inserted through the mounting flange portions 15.

The pinion shaft 3 includes pinion teeth 16 on an outer circumferential surface. According to the present embodiment, the pinion shaft 3 includes the pinion teeth 16 closer to a tip of the outer circumferential surface. The front half of the pinion shaft 3 is disposed within the pinion accommodating portion 13, and is supported by a pair of bearings 17a and 17b to be rotatable only with respect to the pinion accommodating portion 13. Specifically, the tip of the pinion shaft 3 is supported by the sliding bearing 17a to be rotatable with respect to an inner side of the pinion accommodating portion 13. The intermediate portion of the pinion shaft 3 is supported by the single row rolling bearing (ball bearing) 17b such as deep groove type, three-point contact type, or four-point contact type to be rotatable with respect to a portion closer to the opening of the pinion accommodating portion 13. A cap screw cylinder 18 is screwed onto the opening end of the pinion accommodating portion 13 to regulate the axial position of the rolling bearing 17b. A seal ring 19 closes a gap between an inner circumferential surface of the cap screw cylinder 18 and an outer circumferential surface of the pinion shaft 3.

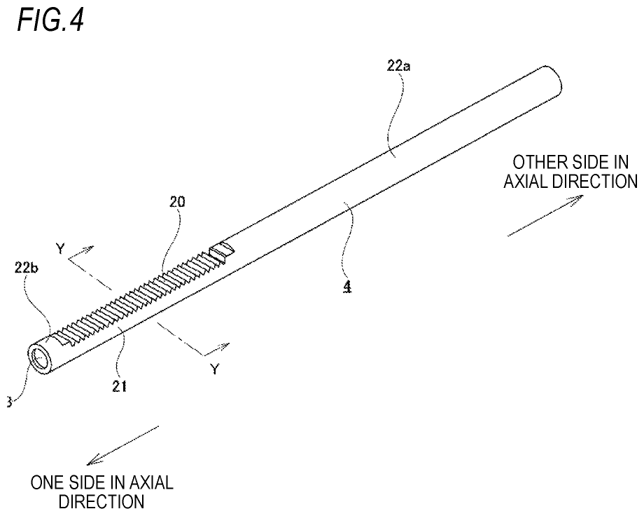

The rack shaft 4 according to the present embodiment is solid. The rack shaft 4 includes a rack portion 21 including rack teeth 20 on a portion of an outer circumferential surface in a circumferential direction. According to the present embodiment, the rack shaft 4 includes the rack teeth 20 on a position biased to one side in the axial direction of the front surface. In other words, the rack shaft 4 includes the rack portion 21 on a position biased to one side in the axial direction (left side in FIG. 4) of the axially intermediate portion, and shaft portions 22a and 22b on a position away from the rack portion 21 in the axial direction. The rack portion 21 has a cross-sectional shape (contour shape) of an approximately D-shape (approximately arc shape), and the shaft portions 22a and 22b have a cross-sectional shape (contour shape) of a circle. The rack shaft 4 has screw holes 23 open on end surfaces of both sides in the axial direction. Such rack shaft 4 is formed of, for example, an iron-based alloy such as carbon steel (S45C to S58C, or the like) or chromium molybdenum steel (SCM415 to SCM440, or the like).

The rack shaft 4 is supported to reciprocate in the axial direction (left and right direction) within the rack accommodating portion 12 by a rack bush 24 disposed within a portion closer to the other end of the axial direction of the rack accommodating portion 12, so that the rack teeth 20 are engaged with the pinion teeth 16. The ends of both sides in the axial direction of the rack shaft 4 protrude from the openings on both sides of the rack accommodating portion 12 in the axial direction, and are connected to base ends of the tie rods 9 through spherical joints 25 screw-fixed to the screw holes 23. The tips of the tie rods 9 are each connected to the tips of knuckle arms (not illustrated) by pivots. The rack shaft 4 does not rotate around its own center axis by the engagement between the pinion teeth 16 and the rack teeth 20.

The rack portion 21 has the hardened layer 26 over the entire circumference on a radially outer portion (surface layer portion) including the rack teeth 20. As described below, the hardened layer 26 is formed on the radially outer portion of the rack shaft 4 (the rack portion 21) by performing heat treatment on at least a portion of the rack shaft 4 including the rack portion 21, and does not reach the center. That is, the rack portion 21 has a non-hardened layer 27 in the center. The hardened layer 26 is continuous in the circumferential direction of the rack portion 21, and has a ring shape (D-ring shape) from a cross-section orthogonal to the center axis O₄ of the rack shaft 4. The depth of the hardened layer 26 is described below.

The pressing mechanism 11 presses the rack shaft 4 toward the pinion shaft 3, and includes a rack guide 28 provided within the cylinder portion 14, a cover 29 screwed onto the opening of the cylinder portion 14, and a coil spring 30 disposed between the rack guide 28 and the cover 29. The rack guide 28 is disposed within the cylinder portion 14 to move in the front and rear direction which is an axial direction of the cylinder portion 14. Such rack guide 28 has an approximately cylindrical shape, and includes a pressing recess 31 having a partially cylindrical concave surface matching a shape of the back surface of the rack shaft 4 on the end surface of the front side toward the back surface of the rack shaft 4 to support the rack shaft 4 in a slidable manner. A synthetic resin sheet 32 having excellent sliding property is attached to a surface of the pressing recess 31.

The pressing mechanism 11 described above elastically presses the rack shaft 4 toward the pinion shaft 3, thereby eliminating backlash of the engaged portion between the pinion teeth 16 and the rack teeth 20. The engagement state between the pinion teeth 16 and the rack teeth 20 is maintained properly regardless of the force applied to the rack shaft 4 in the direction of parting away from the pinion shaft 3 by the power transmission at the engaged portion.

According to the present embodiment, the depth of the hardened layer 26 of the rack shaft 4 is regulated as follows.

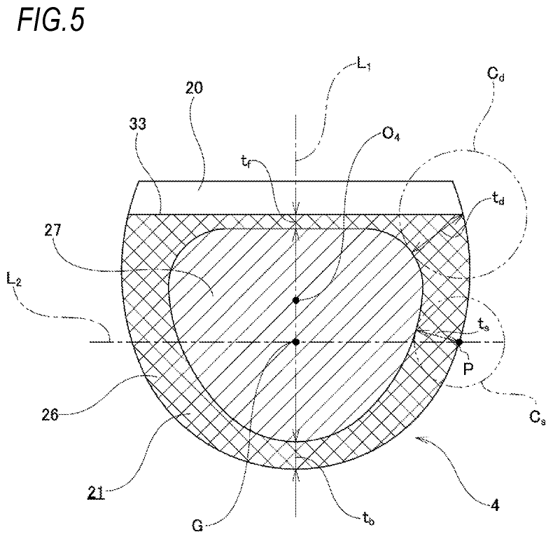

A depth t_{b} of a portion of the hardened layer 26 on the opposite side to the rack teeth 20 in the radial direction, that is, the portion of the hardened layer 26 on the back surface side (lower side in FIG. 5) is formed to be shallower (smaller) than a depth tₛ of portions of the hardened layer 26 on both sides in a tooth width direction of the rack teeth 20 (left and right direction in FIG. 5) (t_{b}<tₛ). In the illustrated embodiment, the depths tₛ of the portions of the hardened layer 26 on both sides of the rack teeth 20 in the tooth width direction are same as each other, but when the disclosure is implemented, the depths may be different from each other as long as size relations with the depth t_{b} of the portion of the hardened layer 26 on the opposite side to the rack teeth 20 in the radial direction are satisfied.

In a cross section orthogonal to the center axis O₄ of the rack shaft 4 (the center axis of the shaft portions 22a and 22b), the depth t_{b} of the portion of the hardened layer 26 on the opposite side to the rack teeth 20 in the radial direction corresponds to, on a straight line L₁ passing through a center of gravity G of the cross section and the center axis O₄ of the rack shaft 4, a depth of the hardened layer 26 on the opposite side to the rack teeth 20 in the radial direction. In the cross section orthogonal to the center axis O₄ of the rack shaft 4, where L₂ is a straight line passing through the center of gravity G of cross section and orthogonal to the straight line L₁, the depth tₛ of the portions of the hardened layer 26 on both sides of the rack teeth 20 in the tooth width direction corresponds to a radius of a circle Cₛ that is centered on an intersection P of the straight line L₂ and the outline (outer circumferential surface) of the rack shaft 4 and that contacts a boundary between the hardened layer 26 and the non-hardened layer 27.

A depth t_{d} of a portion of the hardened layer 26 on a radially inner side of an end of a tooth bottom 33 in the tooth width direction between the adjacent rack teeth 20 in the axial direction is deeper (bigger) than the depth tₛ of the portions of the hardened layer 26 on both sides of the rack teeth 20 in the tooth width direction (t_{d}>tₛ).

The depth t_{d} of the portion of the hardened layer 26 on the radially inner side of the end of the tooth bottom 33 in the tooth width direction between the adjacent rack teeth 20 in the axial direction corresponds to a radius of a circle C_{d} that is centered on an end of the tooth bottom 33 in the tooth width direction and that contacts the boundary between the hardened layer 26 and the non-hardened layer 27 in the cross section orthogonal to the center axis O₄ of the rack shaft 4.

Briefly, according to the present embodiment, the depth of the hardened layer 26 becomes shallower in order from the portion on the radially inner side of the end of the tooth bottom 33 in the tooth width direction, the portions on both sides of the rack teeth 20 in the tooth width direction, and the portion on the opposite side to the rack teeth 20 (back surface side) in the radial direction (t_{d}>tₛ>t_{b}). More specifically, according to the present embodiment, the depth of the hardened layer 26 becomes gradually shallower in the circumferential direction from the portion on the radially inner side of the end of the tooth bottom 33 in the tooth width direction, toward the portion on the opposite side to the rack teeth 20 in the radial direction. That is, the depth of the hardened layer 26 becomes gradually shallower in the circumferential direction as the position becomes farther from the portion on the radially inner side of the end of the tooth bottom 33 in the tooth width direction (the portion having the depth t_{d}) and closer to the portion on the straight line L₁ passing through the center of gravity G and the center axis O₄. A depth of the hardened layer 26 of a portion of the hardened layer 26 other than the depth t_{b} of the portion on the back surface side, the depth tₛ of the portions on both sides of the rack teeth 20 in the tooth width direction, and the depth t_{d} of the portion on the radially inner side of the end of the tooth bottom 33 in the tooth width direction corresponds to a radius of a circle that is centered on a point on the outline (outer circumferential surface) of the rack shaft 4 and that contacts the boundary between the hardened layer 26 and the non-hardened layer 27.

Here, because the rack portion 21 has the cross-sectional shape (contour shape) of approximately D-shape (approximately arc shape), and because the portion of the rack portion 21 other than the rack teeth 20 are curved and have no sharp angle, it is easy to make the depth of the hardened layer 26 become gradually shallower as mentioned above. When the portion of the rack portion 21 other than the rack teeth 20 has a sharp angle, it is difficult to control heat treatment, structure, and hardness, which is not preferable. In particular, because heat easily enters and exits the angle portion, the hardened layer is easily thickened by the heat treatment.

In the illustrated example, in the hardened layer 26, a depth t_{f} of a portion on a radially inner side of an intermediate portion (center) of the tooth bottom 33 in the tooth width direction is shallower than the depth t_{b} of the portion on the opposite side to the rack teeth 20 in the radial direction (t_{f}<t_{b}). In addition to the condition t_{d}>tₛ>t_{b} described above, it was found by the experiments conducted by the present inventors that, by reducing the depth t_{f} to satisfy t_{f}<t_{b} (t_{d}>tₛ>t_{b}>t_{f}), the Young's modulus of the rack portion 21 becomes higher, distortion hardly reaches the rack teeth 20, and therefore, it is difficult for the rack shaft 4 to reach the limit of destruction.

Meanwhile, the depth t_{f} of the portion of the hardened layer 26 on the radially inner side of the intermediate portion of the tooth bottom 33 in the tooth width direction is not limited particularly and can be deeper than the depth t_{b} as long as the depth t_{d} of the portion on the radially inner side of the end of the tooth bottom 33 in the tooth width direction can be ensured sufficiently.

The hardened layer 26 refers to a portion that is hardened by induction hardening treatment and a portion having a Vickers hardness (Hv) of 450 or more, preferably 550 or more, and more preferably 600 or more.

The depth of the hardened layer 26 is properly determined by the metal material forming the rack shaft 4, the outer diameter (the outer diameter of the shaft portions 22a, 22b), and the like. Specifically, for example, when forming the rack shaft 4 by carbon steel (S48C) containing 0.45% to 0.51% of carbon, the depth t_{d} of the portion of the hardened layer 26 on the radially inner side of the end of the tooth bottom 33 in the tooth width direction can be set to 6% or more and 35% or less of the outer diameter D of the rack shaft 4 (the shaft portions 22a, 22b). The outer diameter D of the rack shaft 4 is equal to the outer diameter (material diameter) of spare materials 34 to be described below. The depth t_{b} of the portion of the hardened layer 26 on the opposite side to the rack teeth 20 in the radial direction can be set to 40% or more and 70% or less, and preferably 50% or more and 60% or less of the depth t_{d} of the portion of the hardened layer 26 on the radially inner side of the end of the tooth bottom 33 in the tooth width direction.

The rack shaft 4 described above can be manufactured as follows, for example.

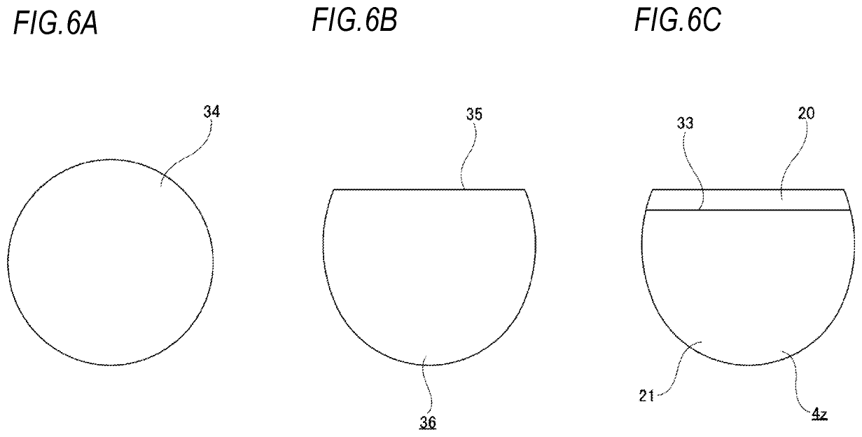

As illustrated in FIG. 6A, a metal bar material having a circular cross-sectional shape is cut to a predetermined length to obtain a cylindrical spare material 34 having an outer diameter that does not change in the axial direction. By performing thermal refining treatment on the spare material, the hardness of the spare material 34 becomes about 180 to 320 in Vickers hardness (Hv).

Then, by performing pressing (flat pressing) only on a portion of the spare material 34 where the rack portion 21 is to be formed, a flat surface portion 35 is formed on a portion to be a front surface when completed, and an intermediate material 36 having a cross sectional shape of an approximately D-shape is obtained, as illustrated in FIG. 6B. According to the present embodiment, while the back surface of the spare material 34 is restrained by the mold, the portion of the spare material 34 where the rack portion 21 is to be formed is pressed with a punch to form the flat surface portion 35. Therefore, the back surface of the intermediate material 36 is formed by a cylindrical surface whose diameter is approximately same as the material diameter. Meanwhile, in the intermediate material 36, surface on both sides in the width direction (left and right sides in FIG. 6B) are formed by a convex curved surface having a diameter larger than the material diameter.

Then, the rack teeth 20 are formed by performing tooth formation such as pressing and/or cutting on the flat surface portion 35 of the intermediate material 36. The screw holes 23 are formed by drilling on the end surfaces of both sides in the axial direction. Accordingly, as in FIG. 6C, a rack shaft 4z before heat treatment is obtained. The steps for obtaining the rack shaft 4z from the metal bar can be changed or performed simultaneously as long as no contradiction occurs.

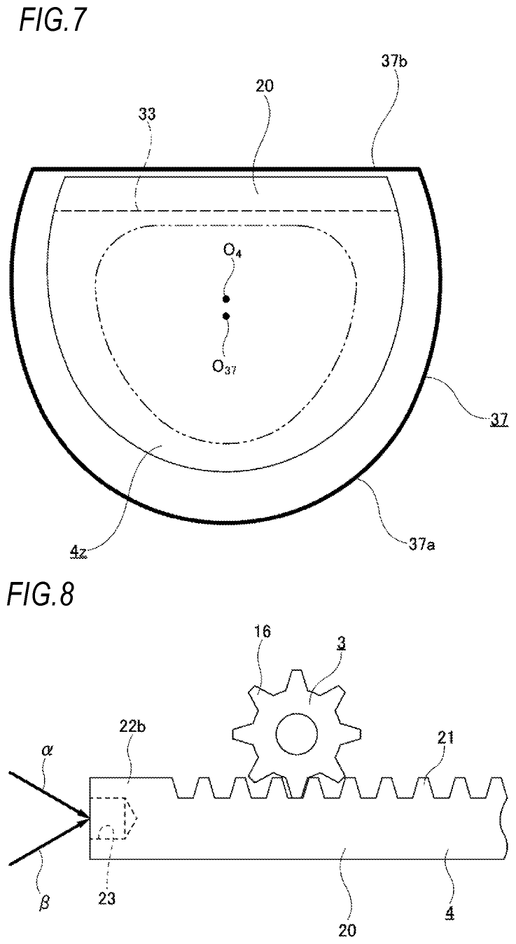

Then, the rack shaft 4 can be obtained from the rack shaft 4z before heat treatment, by performing heat treatment on the portion where the rack portion 21 is to be formed and forming the hardened layer 26. According to the present embodiment, the rack shaft 4 can be obtained by performing induction hardening treatment on the rack shaft 4z before heat treatment, and further performing tempering treatment to form the hardened layer 26. A method for performing induction hardening treatment is explained with reference to FIG. 7.

An induction hardening treatment is performed by using an annular high-frequency induction coil 37. The high-frequency induction coil 37 has a similar shape (including an approximately similar shape) that is bigger than the contour shape of the rack portion 21. That is, the high-frequency induction coil 37 has an approximately are-shaped curved portion 37a and a straight portion 37b that connects ends on both sides of the curved portion 37a in the circumferential direction.

The high-frequency induction coil 37 is disposed around the rack shaft 4z, and a center axis O₃₇ of the high-frequency induction coil 37 (a center axis of the curved portion 37a) is disposed to offset the back surface side of the rack shaft 4z (lower side in FIG. 7) with respect to the center axis O₄ of the rack shaft 4z (the center axis of the partial cylindrical surface forming the back surface of the rack shaft 4z). That is, the high-frequency induction coil 37 is disposed so that a distance between an inner circumferential surface of the high-frequency induction coil 37 and an outer circumferential surface of the rack shaft 4z becomes, in the circumferential direction, deeper from the ends on both sides of the tooth bottom 33 in the tooth width direction toward the portion on the opposite side to the rack teeth 20 in the radial direction. Here, the high-frequency induction coil 37 is energized to heat the radially outer portion (surface layer portion) of the rack shaft 4z and then cool down the radially outer portion, thereby performing induction hardening treatment on the rack shaft 4z.

Then, tempering treatment is further performed to form the hardened layer 26 and the rack shaft 4 can be obtained. The tempering treatment can be performed by using the high-frequency induction coil 37 described above or another coil having the same shape, or can be performed by another method. The shaft portions 22a and 22b axially offset from the rack portion 21 may or may not be subjected to heat treatment.

For the rack shaft 4 according to the present embodiment, it is possible to reduce the manufacturing costs can be while ensuring bending strength.

That is, in the hardened layer 26, the depth t_{b} of the portion on the opposite side (back surface side) to the rack teeth 20 in the radial direction, which is hardly cooled due to a small surface size, becomes shallower than the depth tₛ of the portions on both sides in the tooth width direction (t_{b}<tₛ). Therefore, since an amount of heat treatment can be reduced, efficiency of forming the hardened layer 26 can be improved, and the manufacturing cost of the rack shaft 4 can be reduced.

Since the back surface side of the rack portion 21 (the opposite side to the rack teeth 20) mainly receives compressive loads, the back surface side has a simpler shape than that of the rack teeth 20, and stress concentration does not occur, and thus strength is relatively high. When considering the heat treatment, since the back surface side of the rack portion 21 has a simple shape and does not abut with the edge, cooling tends to be relatively slow. Therefore, when the heat input increases, it is possible that the crystal grain size of the surface and core structures may increase, thus leading to decreasing strength and toughness. Therefore, making the depth t_{b} of the hardened layer on the back surface side of the rack portion 21 shallow as described above can result in sound structure and sufficient strength.

With reference to FIG. 8, the reason that it is possible to ensure sufficient bending strength of the rack shaft 4 against the load applied from the tie rods 9 when the steering gear unit 5 is used (while a vehicle equipped with the steering device 1 is driving) will be described.

When the steering angle is applied to the steering wheel while the handlebar 2 is being operated, the inclination angle of the tie rods 9 with respect to the rack shaft 4 in the front and rear direction (inclination angle viewed from the up and down direction) changes. In the illustrated example, when the handlebar 2 is turned (rotated) to the right, the rack shaft 4 is moved toward one side in the axial direction (left side in FIG. 8) and pushes the tie rod 9 on the one side in the axial direction. Here, a reaction force in the direction indicated by an arrow α in FIG. 8 is applied to the rack shaft 4. Based on the reaction force, in the rack shaft 4, a tensile load is applied to a portion on the side of the rack teeth 20, and compressive load is applied to a portion on the opposite side (back surface side) to the rack teeth 20 in the radial direction. That is, while the tensile load is being applied to the side of the rack teeth 20 of the rack shaft 4 and stress tends to be concentrated on the rack teeth 20, the compressive load is applied to the portion on the opposite side to the rack teeth 20 in the radial direction. The portion of the rack shaft 4 on the opposite side to the rack teeth 20 in the radial direction has a simple shape, and stress concentration is hardly generated. Therefore, even when the depth t_{b} of the portion of the hardened layer 26 on the opposite side to the rack teeth 20 in the radial direction is formed to be shallow, under relatively severe load conditions in which the tensile load is applied to the portion on the side of the rack teeth 20 of the rack shaft 4 and stress tends to concentrate on the rack teeth 20, it is possible to ensure sufficient bending strength of the rack shaft 4 against the load applied from the tie rods 9. Therefore, since it is possible to ensure bending strength of the rack shaft 4, the rack shaft 4 can be made smaller and lighter, and material costs can be reduced.

When force is applied from the tie rods 9 to the rack shaft 4 in the direction of an arrow β in FIG. 8, tensile load is applied to the portion on the opposite side (back surface side) to the rack teeth 20 of the rack shaft 4 in the radial direction while the compressive load is applied to the portion on the side of the rack teeth 20. Therefore, stress concentration on the rack teeth 20 is hardly generated, and the load conditions are relatively loosened. In brief, the rack shaft 4 may be designed to ensure sufficient bending strength under relatively severe conditions in which the tensile load is applied to the portion on the side of the rack teeth 20.

According to the present embodiment, the depth t_{d} of the portion of the hardened layer 26 on the radially inner side of the end of the tooth bottom 33 in the tooth width direction between the adjacent rack teeth 20 in the axial direction is deeper than the depth tₛ of the portions of the hardened layer 26 on both sides of the rack teeth 20 in the tooth width direction (t_{d}>tₛ). Therefore, in use state, the strength of the rack teeth 20 against the tensile load applied from the tie rods 9 can be ensured sufficiently.

With the manufacturing method according to the present embodiment, while the high-frequency induction coil 37 is disposed around the rack shaft 4z, and the center axis O₃₇ of the high-frequency induction coil 37 is offset to the back surface side of the rack shaft 4z with respect to the center axis O₄ of the rack shaft 4z, induction hardening treatment can be performed by energizing the high-frequency induction coil 37. Therefore, it is easy to form the hardened layer 26 having the depth which becomes shallower in order from the portion on the radially inner side of the end of the tooth bottom 33 in the tooth width direction, the portions on both sides of the rack teeth 20 in the tooth width direction, and the portion on the opposite side to the rack teeth 20 in the radial direction.

According to the present embodiment, the cylindrical spare material 34 is pressed to form the flat surface portion 35, and then the rack teeth 20 are formed on the flat surface portion 35. Therefore, it is easy to increase the tooth width of the rack teeth 20 compared to a case in which the rack teeth are directly formed on the partial cylindrical surface without forming the flat surface portion 35.

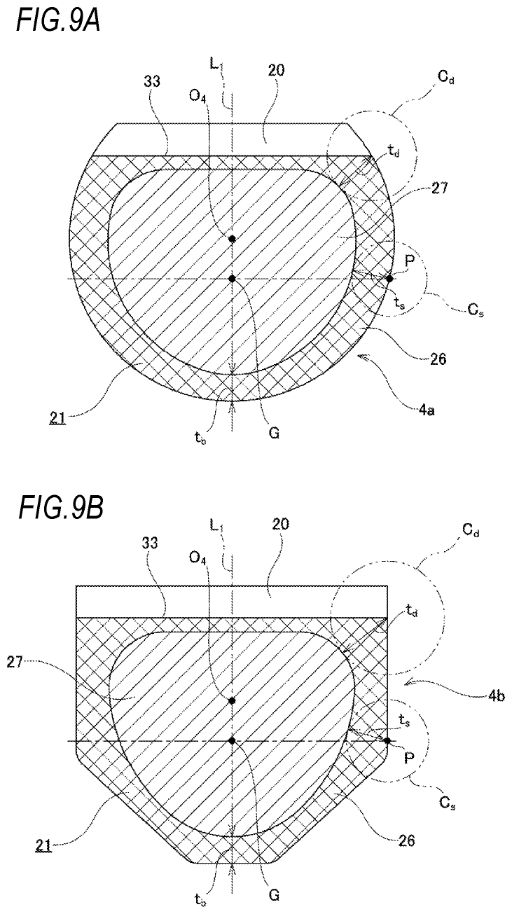

However, the disclosure can also be applied to a rack shaft 4a in which the rack teeth 20 are directly formed on a partial cylindrical surface, as illustrated in FIG. 9A. The disclosure can also be applied to a rack shaft 4b having an approximately trapezoidal cross-sectional shape, as illustrated in FIG. 9B. The rack shaft 4a illustrated in FIG. 9A and the rack shaft 4b illustrated in FIG. 9B are solid. Even in the cases of the rack shaft 4a of FIG. 9A and the rack shaft 4b of FIG. 9B, the depth of the hardened layer 26 becomes shallower in order from the portion on the radially inner side of the end of the tooth bottom 33 in the tooth width direction, the portions on both sides of the rack teeth 20 in the tooth width direction, and the portion on the opposite side (back surface side) to the rack teeth 20 in the radial direction (t_{d}>tₛ>t_{b}). In the rack shaft 4a illustrated in FIG. 9A, the depth of the hardened layer 26 becomes gradually shallower in the circumferential direction from the portion on the radially inner side of the end of the tooth bottom 33 in the tooth width direction, toward the portion on the opposite side to the rack teeth 20 in the radial direction. Meanwhile, for the rack shaft 4b illustrated in FIG. 9B, the depth of the hardened layer 26 does not become gradually shallower in the circumferential direction from the portion on the radially inner side of the end of the tooth bottom 33 in the tooth width direction, toward the portion on the opposite side to the rack teeth 20 in the radial direction. However, for the rack shaft 4b illustrated in FIG. 9B, the depth of the hardened layer 26 can be set to be gradually shallower in the circumferential direction from the portion on the radially inner side of the end of the tooth bottom 33 in the tooth width direction, toward the portion on opposite side to the rack teeth 20 in the radial direction.

According to the present embodiment, although the disclosure is described with a rear-pulling type of steering gear unit in which the pinion shaft 3 is disposed in front of the rack shaft 4, and the rack shaft is disposed behind the center axis of the axle of the steering wheels (front wheels), the disclosure can be also applied to a front-pulling type of steering gear unit in which the pinion shaft is disposed behind the rack shaft, and the rack shaft is disposed in front of the center axis of the axle of the steering wheels.

The disclosure is not limited to a rack shaft including a rack portion on only one position in the axial direction, but can be applied to a rack shaft for a dual pinion type electric power steering device including rack portions on two positions in the axial direction. Here, only for the hardened layer provided in one of the two rack portions, the depth of a portion on the opposite side to the rack teeth in the radial direction can also be shallower than the depth of the portions on both sides of the rack teeth in the tooth width direction, and with respect to the hardened layer provided on both rack portions, the depth of the portion on the opposite side to the rack teeth in the radial direction can be shallower than the depth of the portions on both sides of the rack teeth in the tooth width direction.

According to the present embodiment, in a cross section orthogonal to the center axis O₄ of the rack shaft 4, the cross-sectional shape of the rack shaft 4 and the depth of the hardened layer 26 are symmetrical with respect to the tooth width direction of the rack teeth 20. However, as long as the relation is satisfied in which the depth of the portion of the hardened layer on the opposite side to the rack teeth in the radial direction is shallower than the depth of the portions of the hardened layer on both sides of the rack teeth in the tooth width direction, and preferably, an additional relation is satisfied in which the depth of the portion of the hardened layer on the radially inner side of the end of the tooth bottom in the tooth width direction between the adjacent rack teeth in the axial direction is deeper than the depth of the portions of the hardened layer on both sides of the rack teeth in the tooth width direction, the cross-sectional shape of the rack shaft and/or the depth of the hardened layer may be non-symmetrical in the tooth width direction.

This application is based upon Japanese Patent Application (Application No. 2021-135439), filed on Aug. 23, 2021, the entire contents of which are incorporated herein by reference.

### REFERENCE SIGNS LIST

1 steering device
2 handlebar
3 pinion shaft
4, 4a, 4b, 4z rack shaft
5 steering gear unit
6 steering shaft
7 universal joint
8 intermediate shaft
9 tie rod
10 housing
11 pressing mechanism
12 rack accommodating portion
13 pinion accommodating portion
14 cylinder portion
15 mounting flange portion
16 pinion teeth
17a, 17b bearing
18 cap screw cylinder
19 seal ring
20 rack teeth
21 rack portion
22a, 22b shaft portion
23 screw hole
24 rack bush
25 spherical joint
26 hardened layer
27 non-hardened layer
28 rack guide
29 cover
30 coil spring
31 pressing recess
32 sheet
33 tooth bottom
34 spare material
35 flat surface portion
36 intermediate material
37 high-frequency induction coil
37a curved portion
37b straight portion

1. A rack shaft comprising:
a rack portion including rack teeth on an outer circumferential surface, wherein:
the rack portion has a hardened layer over an entire circumference on a radially outer portion including the rack teeth; and
a depth of a portion of the hardened layer on an opposite side to the rack teeth in a radial direction is shallower than a depth of portions of the hardened layer on both sides of the rack teeth in a tooth width direction.

2. The rack shaft according to claim 1, wherein a depth of a portion of the hardened layer on a radially inner side of an end of a tooth bottom in the tooth width direction between adjacent rack teeth in the axial direction is deeper than the depth of the portions of the hardened layer on both sides of the rack teeth in the tooth width direction.

3. The rack shaft according to claim 2, wherein the depth of the hardened layer becomes gradually shallower in a circumferential direction, from the portion on the radially inner side of the end of the tooth bottom in the tooth width direction, toward the portion on the opposite side to the rack teeth in the radial direction.

4. The rack shaft according to claim 3, wherein a depth of a portion of the hardened layer on a radially inner side of an intermediate portion of the tooth bottom in the tooth width direction is shallower than the depth of the portion on the opposite side to the rack teeth in the radial direction.

5. A method for manufacturing the rack shaft according to claim 3 or 4, the method comprising:
performing heat treatment on the rack portion by energizing a high-frequency induction coil disposed around the rack portion, wherein
while performing the heat treatment on the rack portion, a center axis of the high-frequency induction coil is disposed to be offset from a center axis of the rack portion to the opposite side to the rack teeth in the radial direction.

6. A rack and pinion type steering gear unit comprising:
a pinion shaft including pinion teeth on an outer circumferential surface; and
a rack shaft including a rack portion including rack teeth engaged with the pinion teeth on a portion in a circumferential direction of an outer circumferential surface, wherein
the rack shaft is configured with the rack shaft according to any one of claims 1 to 4.
